(19) United States
(12) Patent Application Publication
(10) Pub. No.: US 2017/0241471 A1
(43) Pub. Date: Aug. 24, 2017

(54) COMPOSITE VEHICLE SHAFT ASSEMBLY

(71) Applicant: GM GLOBAL TECHNOLOGY OPERATIONS LLC, Detroit, MI (US)

(72) Inventors: Dale E. Murrish, Troy, MI (US); Amit Kumar, Rochester Hills, MI (US); Scott A. Hucker, Ortonville, MI (US)

(21) Appl. No.: 15/359,864

(22) Filed: Nov. 23, 2016

Related U.S. Application Data
(63) Continuation-in-part of application No. 15/048,322, filed on Feb. 19, 2016.

(51) Int. Cl. F16C 3/02; F16H 57/04; F16H 53/02

(52) U.S. Cl. CPC F16C 3/023; F16H 53/02; F16H 57/043

(57) ABSTRACT

A composite vehicle shaft assembly includes a body formed from a first material having a first end, a second end, and an intermediate portion extending therebetween. The intermediate portion defines an axis of rotation and includes an outer surface and an inner surface defining a cavity. At least one core plug formed from a second material is disposed in the cavity.

### CROSS-REFERENCE TO RELATED APPLICATIONS

This application is a continuation-in-part of U.S. patent application Ser. No. 15/048,322, which was filed on Feb. 19, 2016. The entire contents of U.S. patent application Ser. No. 15/048,322 are incorporated herein by reference.

### TECHNICAL FIELD

The present teachings generally include a shaft assembly for a vehicle, and a method of manufacturing a shaft assembly.

### BACKGROUND

An engine crankshaft converts reciprocating linear movement of a piston into rotational movement about a longitudinal axis to provide torque to propel a vehicle, such as but not limited to a train, a boat, a plane, a truck, or an automobile.

Valves are operable to control air flow into and out of the engine cylinders. Camshafts are driven by an engine crankshaft and are operatively connected to the valves to control opening and closing of the valves.

Engines are often equipped with balance shafts rotatably connected to the engine crankshaft via a chain or belt and sprocket, or a gear train. The balance shafts have counterweights that help to counter vibrational forces created by the pistons.

Transmissions, gear boxes, rear axles and other drivetrain components have various torque transfer shafts. For example, various shafts support gears in a gear train that mesh with one another and establish a speed ratio from an input member to an output member.

Reducing the weight of vehicle components is desirable for improving vehicle fuel economy. However, the size of vehicle components must be sufficient to bear the stresses experienced during operation, thus limiting the potential weight reduction.

### SUMMARY

Disclosed is a composite vehicle shaft assembly including a body formed from a first material including a first end, a second end, and an intermediate portion extending therebetween. The intermediate portion defines an axis of rotation and includes an outer surface and an inner surface defining a cavity. At least one core plug formed from a second material is disposed in the cavity.

Also disclosed is a method of manufacturing a composite vehicle shaft assembly including disposing at least one core plug formed from a first material in a cavity formed in a shaft body formed from a second material.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic side view illustration of a first embodiment of a balance shaft assembly in accordance with the present teachings;

FIG. 2 is a schematic cross sectional illustration of a portion of the balance shaft assembly of FIG. 1 taken at lines 2-2 in FIG. 1;

FIG. 3 is a schematic cross-sectional illustration of an alternative embodiment of a balance shaft assembly within the scope of the present teachings;

FIG. 4 is a schematic cross-sectional illustration of an alternative embodiment of a balance shaft assembly within the scope of the present teachings;

FIG. 5 is a schematic cross-sectional illustration of the balance shaft assembly of FIG. 4, taken at lines 5-5 in FIG. 4;

FIG. 6 is a schematic cross-sectional illustration of an alternative embodiment of a balance shaft assembly;

FIG. 7 is a schematic perspective illustration of a camshaft assembly within the scope of the present teachings;

FIG. 8 is a cross-sectional illustration of a portion of the camshaft assembly of FIG. 7 taken at lines 8-8 in FIG. 7;

FIG. 9 is a cross-sectional illustration of an alternative embodiment of a camshaft assembly within the scope of the present teachings;

FIG. 10 is a schematic cross-sectional illustration of the camshaft assembly of FIG. 9, taken at lines 10-10 in FIG. 9;

FIG. 11 is a schematic cross-sectional illustration of the camshaft assembly of FIG. 9, taken at lines 11-11 in FIG. 9;

FIG. 12 is a schematic cross-sectional illustration of the camshaft assembly of FIG. 9, taken at lines 12-12 in FIG. 9;

FIG. 13 is a schematic cross-sectional illustration of the camshaft assembly of FIG. 9, taken at lines 13-13 in FIG. 9;

FIG. 14 is a schematic cross-sectional illustration of the camshaft assembly of FIG. 9, with an alternative core plug disposed in the cavity at the location of the cross-section of FIG. 10;

FIG. 15 is a schematic cross-sectional illustration of the camshaft assembly of FIG. 9, with the alternative core plug disposed in the cavity at the location of the cross-section of FIG. 11;

FIG. 16 is a schematic cross-sectional illustration of the camshaft assembly of FIG. 9, with the alternative core plug disposed in the cavity at the location of the cross-section of FIG. 12;

FIG. 17 is a schematic cross-sectional illustration of the camshaft assembly of FIG. 9, with the alternative core plug disposed in the cavity at the location of the cross-section of FIG. 13;

FIG. 18 is a schematic cross-sectional illustration of another alternative camshaft assembly;

FIG. 19 is a schematic cross-sectional illustration of another alternative camshaft assembly;

FIG. 20 is a schematic cross-sectional illustration of another alternative camshaft assembly;

FIG. 21 is a schematic cross-sectional illustration of another alternative camshaft assembly;

FIG. 22 is a schematic cross-sectional illustration of a portion of an alternative powertrain shaft assembly taken at lines 22-22 in FIG. 23;

FIG. 23 is a schematic cross-sectional illustration of a portion of an alternative powertrain shaft assembly taken at lines 23-23 in FIG. 22;

FIG. 24 is a schematic cross-sectional illustration of a portion of another alternative powertrain shaft assembly;

FIG. 25 is a schematic cross-sectional illustration of a transmission shaft assembly with a core plug disposed within a transmission shaft within the scope of the present teachings;

FIG. 26 is a schematic cross-sectional illustration of a transmission shaft clutch assembly with a core plug disposed within a transmission shaft within the scope of the present teachings;

FIG. 27 is a partial cross-sectional view of a composite driveshaft, in accordance with another aspect of an exemplary embodiment;

FIG. 28 is a cross-sectional view of the composite driveshaft of FIG. 27 illustrating a core plug, in accordance with an aspect of an exemplary embodiment;

FIG. 29 is a cross-sectional view of the composite driveshaft of FIG. 27 illustrating a core plug, in accordance with another aspect of an exemplary embodiment;

FIG. 30 is a cross-sectional view of the composite driveshaft of FIG. 27 illustrating a core plug, in accordance with yet another aspect of an exemplary embodiment;

FIG. 31 is a partial cross-sectional view of a composite driveshaft, in accordance with still another aspect of an exemplary embodiment; and

FIG. 32 is a partial cross-sectional view of a composite transfer gear shaft, in accordance with an aspect of an exemplary embodiment.

### DETAILED DESCRIPTION

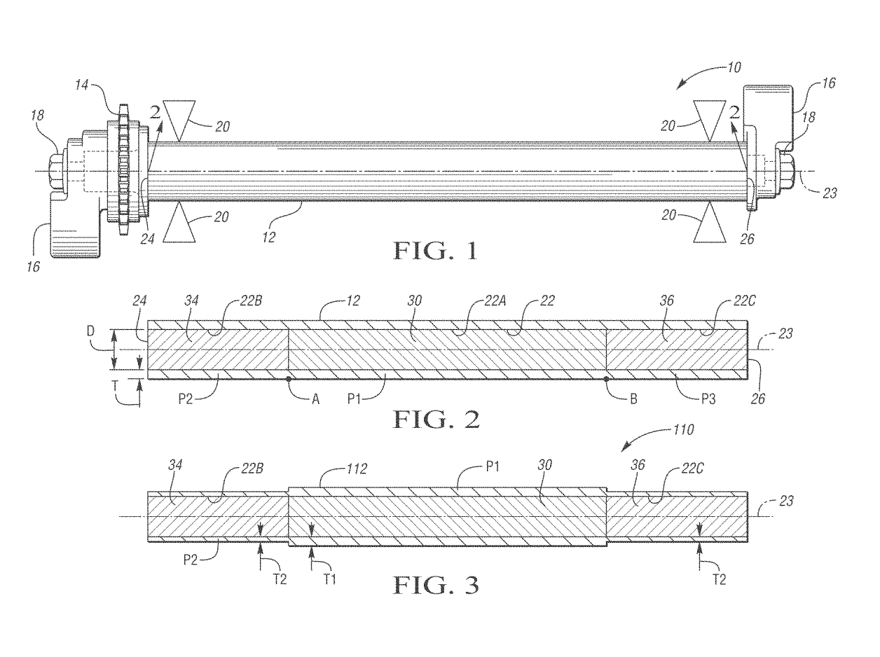

Referring to the Figures, wherein like numerals indicate like parts throughout the several views, FIG. 1 shows a balance shaft assembly 10 that includes a balance shaft 12. A sprocket 14 is mounted on the balance shaft 12 and operatively connects the balance shaft 12 to rotate with a crankshaft via a chain (not shown). Counterweights 16 are mounted in opposing directions at ends of the balance shaft 12. Retaining bolts 18 retain the counterweights 16 in position on the balance shaft 12. Bearings 20, schematically represented by triangles, rotatably mount the balance shafts on an engine block (not shown). Those skilled in the art will readily understand the use of balance shafts to counter engine vibrations. Additionally, although FIGS. 2-6 are described with respect to a balance shaft, the features shown and described with respect to FIG. 6 may be used for other types of powertrain shafts within the scope of the present teachings. For example, camshafts, transmission shafts or other powertrain shafts may include any of the features shown and described herein.

For weight reduction, the balance shaft 12 has a cavity 22 that extends along a longitudinal axis 23 at least partially from a first axial end 24 to a second axial end 26 of the shaft 12. In the embodiment shown, the cavity 22 extends completely from the first axial end 24 to the second axial end 26. In various embodiments, the shaft 12 may be extruded with the cavity 22, or the cavity 22 may be drilled in the shaft 12. The inner diameter D of the shaft 12 and the resulting thickness T of the shaft 12 must be configured to withstand the stresses of operation and maximum engine speed while elastically deforming only within acceptable limits. By disposing a first core plug 30 in a strategic location within the cavity 22, the core plug 30 increases the stiffness of the shaft assembly 10. With the core plug 30, the diameter D may be greater than if the cavity 22 was empty. The resulting lower thickness T of the wall of the tubular shaft 12 reduces the overall weight of the shaft 12. This volume of material reduced in the shaft 12 may be greater than the added volume of the core plug 30. Accordingly, the overall weight of the shaft assembly 10 may be reduced even if the core plug 30 is the same material as the shaft 12. If the core plug 30 is a less dense material than the shaft 12, an even greater reduction in weight is achieved. The combination of the cross sectional geometry of the core plug 30 combined with the lower thickness T of the shaft 12 produces a composite shaft 10 with lower overall mass.

In FIG. 2, the core plug 30 is referred to as a first core plug. The core plug 30 is disposed in a first portion 22A of the cavity 22 at a first portion of the shaft 12 indicated as a portion P1 extending generally from position A to position B. As shown in FIG. 2, the first core plug 30 is aligned with a first portion P1. The second portion 22B of the cavity 22 is at a second portion P2 of the shaft 12 that extends from the first axial end 24 to the position A. A third portion 22C of the cavity 22 is at a third portion P3 of the shaft 12 that extends from the second axial end 26 to a position B. Because of the lower stress level, the second portion P2 and the third portion P3 of the shaft 12 are subjected to a second level of stress less than the first level of stress, as may be determined by finite element analysis, by in-use testing, or otherwise. Depending on the level of stress that must be borne, the second portion P2 and the third portion P3 may optionally be left empty (as shown in FIG. 4) so that the shaft 12 is hollow at the second portion P2 and the third portion P3. In the embodiment of FIG. 2, however, a second core plug 34 is disposed in the second portion 22B of the cavity 22 aligned with a second portion P2. Similarly, a third core plug 36 is disposed in the third portion 22C of the cavity 22 aligned with a third portion P3. The first core plug 30 may have a first density, and the second core plug 34 as well as the third core plug 36 may have a second density that is less than the first density. The density of the first core plug 30 may be the same as the density of the shaft 12 or less than the density of the shaft 12. In addition, the cross sectional area of the second core plug 34 and the third core plug 36 may be less than that of the first core plug 30.

Any of the core plugs described herein may be at least partially aluminum, at least partially titanium, ceramic, a metal matrix, or a composite. As used herein, a “composite” when used to describe a component, such as a core plug, is a material that is a composite of a polymer and another material. For example, a composite may be a glass-reinforced nylon, a glass-reinforced Acrylonitrile Butadiene Styrene (ABS), a glass-filled thermoset, a glass-filled Polybutylene Terephthalate (PBT), a glass-filled Polyethylene terephthalate (PET), or other polymer composite. Other materials may be used within the scope of the present teachings.

A method of manufacturing a shaft assembly 10 includes configuring the shaft 12 with a cavity 22 that extends at least partially from a first axial end 24 to a second axial end 26 and opens at at least one of the first axial end 24 and the second axial end 26. For example, the shaft 12 may be configured with the cavity by casting the shaft 12 with the cavity 22, such as by placing a temporary core in a mold when the shaft 12 is cast, casting the shaft 12 around the temporary core, and then removing the temporary core. The shaft 12 may instead be configured with the cavity 22 by drilling the cavity 22 after the shaft 12 is cast as a solid shaft.

The method further includes disposing the core plug 30 in the cavity 22. This includes aligning the core plug 30 with the first portion 22A of the cavity 22. The second portion 22B of the cavity 22 may be empty. Alternatively, the method may include disposing a second core plug 34 in the second portion 22B, with the second core plug 34 less dense than the first core plug 30.

FIG. 3 shows an alternative embodiment of a balance shaft assembly 110 with a balance shaft 112 in which the outer diameter of the shaft 112 is machined so that the shaft 112 has a reduced thickness in portions where less stiffness is required. For example, although the first portion P1 of the shaft 112 has a first thickness T1 similar to the shaft 12, the second portion P2 and the third portion P3 have a thickness T2 less than the thickness T1. A method of manufacturing the shaft assembly of FIG. 3 would thus include configuring the shaft 112 with an outer diameter at the second portion P2 of the shaft 12 less than an outer diameter at the first portion P1 of the shaft 12, such as by machining the outer diameter of the second portion P2, and also with an outer diameter at the third portion P3 of the shaft 12 less than an outer diameter of the first portion P1 of the shaft 12, such as by machining the outer diameter of the third portion P3.

FIG. 4 shows an alternative embodiment of a balance shaft assembly 210 that has an alternative core plug 230 with an opening 232 that extends from a first axial end 234 to a second axial end 236 of the core plug 230. The opening 232 reduces the volume of the core plug 230, further reducing the weight of the shaft assembly 210. The opening 232 may have a variety of shapes. In the embodiment of FIG. 4, the opening 232 has a generally triangular shape at a cross-section perpendicular to the axis of rotation (i.e., the longitudinal axis 23) of the shaft 12. The triangular shape has rounded corners, and may be referred to as a tri-lobe shape, In other embodiments, the opening could be circular or another shape, or a core plug may be used that has multiple openings extending generally parallel with the axis 23.

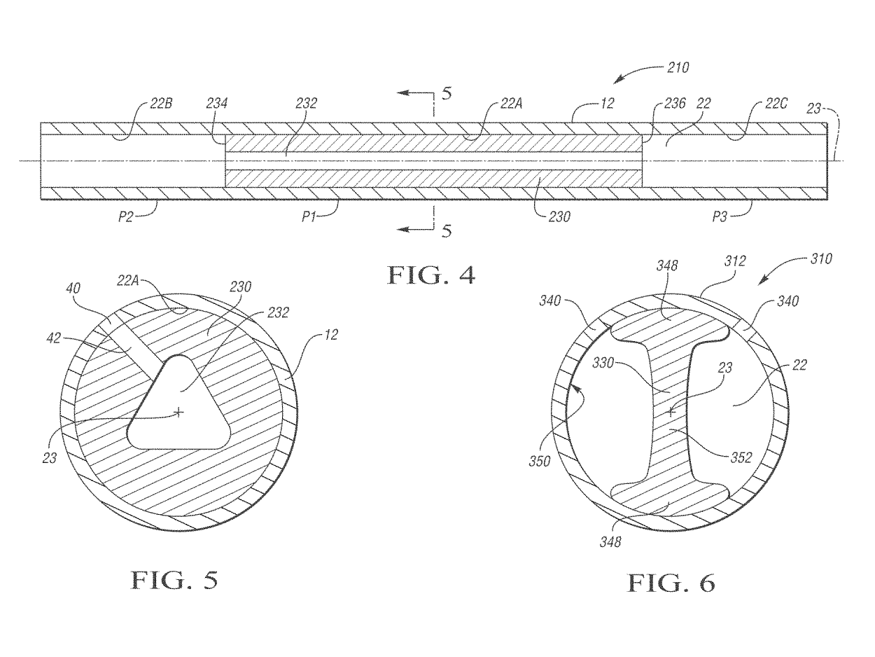

A core plug with a central opening is especially useful in a balance shaft that requires lubrication flow down the center of the shaft. In FIG. 5, the shaft 12 has a lubrication opening 40 extending through the shaft into the cavity 22 (represented by the first portion 22A). The core plug 230 is oriented in the first portion 22A in alignment with the lubrication opening 40 to permit lubricant to flow axially through the center of the cavity 22. More specifically, a passage 42 in the core plug 230 is aligned with the lubrication opening 40 of the shaft 12 and is in communication with the central opening 232. Lubricant can thus flow through the opening 40 and passage 42 to the central opening 232. At another portion of the shaft 12 axially spaced from the opening 40, another passage in the core plug 230 can be aligned with another lubrication opening in the shaft 12 so that the lubricant can be directed into or out of the shaft 12.

FIG. 6 shows another embodiment of a balance shaft assembly 310 with a balance shaft 312 that has two lubrication openings 340 angularly displaced from one another. The balance shaft 312 has a lubrication system that does not require lubricant to flow through the center of the cavity 22. In such a shaft assembly 310, the core plug 330 does not need to have a central opening. For example, a core plug 330 can be used that has an I-beam shape at a cross-section perpendicular to the longitudinal axis 23 of the shaft 312. The core plug 330 is disposed in the cavity 22 so that one of the leg portions 348 of the I-beam is fit to the inner surface 350 of the shaft 312 between the lubrication openings 340. Lubricant can then flow through the openings 340 axially down the cavity 22 on either side of a center portion 352 of the core plug 330.

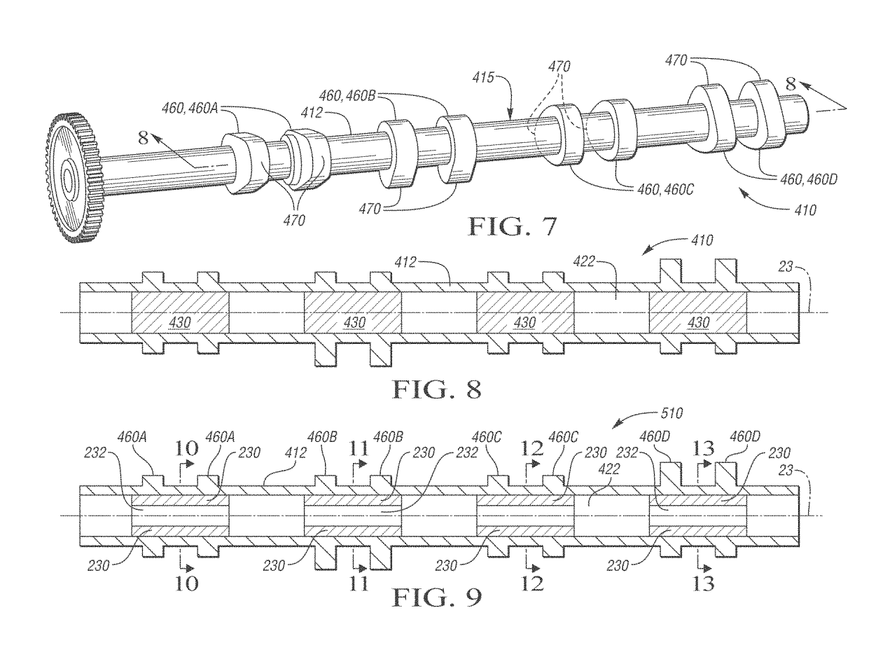

Referring to FIG. 7, a camshaft assembly 410 is shown. The camshaft assembly 410 includes a camshaft 412 with multiple cam lobes 460 at the outer surface 415 of the camshaft 412. The cam lobes 460 include a first pair of cam lobes 460A, a second pair of cam lobes 460B, a third pair of cam lobes 460C, and a fourth pair of cam lobes 460D. As shown in FIG. 8, multiple core plugs 430 can be disposed in a cavity 422 extending through the camshaft 412 so that the core plugs 430 are axially aligned with the cam lobes 460A, 460B, 460C, 460D. In other words, the cam lobes 460 are coaxial with the core plugs 430. Because of the load bearing capability of the core plugs 430, the cavity 422 can be made larger than otherwise, i.e., the thickness of the camshaft 412 can be reduced, reducing the overall weight of the camshaft assembly 410 relative to a camshaft assembly without a core plug.

The camshaft 412 is subjected to greatest stresses at the cam lobes 460, due to the cam lobes 460 acting against the engine valves (not shown). More specifically, the maximum loading on the cam lobe 460 is in a direction inward from a tip of a nose 470 of the cam lobe 460 to the axis 23. The nose 470 is the furthest extremity of the cam lobe 460 and may also be referred to as the distal tip of the cam lobe 460. Accordingly, the core plugs 430 are disposed in the cavity 422 inward of and radially surrounded by the cam lobes 460, with empty portions of the cavity 422 remaining between the core plugs 430. In other words, the core plugs 430 are only made long enough to extend slightly further than the width of the spacing of a pair of the cam lobes 460. The total weight of the core plugs 430 is thus minimized. The core plugs 430 are generally solid but can also have a cross-sectional shape which can be oriented according to the loading on the shaft 12, 112, or 412, or other shaft, as described herein.

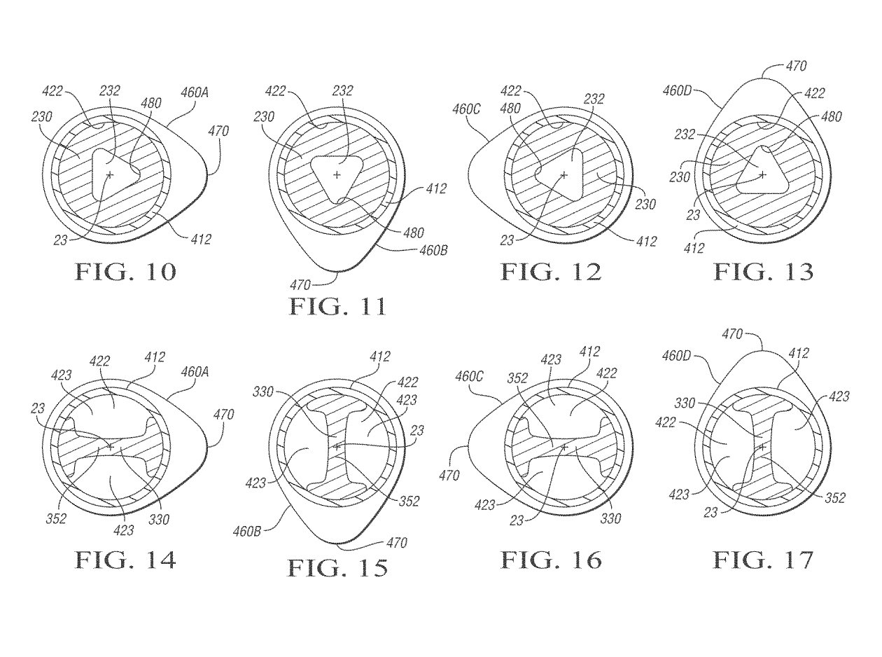

The cross-sectional shape of a core plug, such as core plugs 230 and 330 of FIGS. 5 and 6, can be oriented within the cavity of a camshaft 412 in correlation with loading on the camshaft. As shown in FIGS. 7 and 9, the cam lobes 460A-460D are oriented at different angular orientations about the axis 23. In FIG. 9, a camshaft assembly 510 includes the camshaft 412 with the core plugs 230 disposed in the cavity 422 in alignment with the pairs of cam lobes 460, as described with respect to the core plugs 430 of FIG. 8. In FIG. 9, the core plugs 230 are positioned within the cavity 422 with the predetermined cross-sectional shape of the openings 232 oriented about the axis 23 at a predetermined angular orientation that is correlated with the predetermined maximum loading on the camshaft 412 at the core plug 430. The respective predetermined angular orientation of each opening 232 is correlated with the angular orientation of the nose 470 of the cam lobe 460 that is radially outward of the core plug 430. As is evident in FIGS. 7 and 10-13, the noses 470 are oriented 90 degrees apart from one another in each adjacent pair of cam lobes 460. In FIG. 10, a peak 480 of the triangular opening 232 is aligned with the nose 470 of the cam lobe 460A to which the core plug 230 corresponds. The peak 480 is centered with the center of the nose 470.

FIGS. 14-17 show the camshaft 412 with cam lobes 460A-460D, respectively, and with core plugs 330 like that of FIG. 6 disposed in the cavity 422. The core plugs 330 are disposed in the cavity 422 with the openings 423 (i.e., portions of the cavity 422 on either side of the center portion 352) angularly oriented about the axis 23 so that the center portion 352 is aligned with the nose 470 of the respective cam lobe 460A - 460D. In this position, the core plug 330 best bears the loading on the nose 470.

In any of the embodiments of FIGS. 7-17 the oriented core plug 230 or 330 may be aligned with lubrication openings in the shaft 412 as discussed with respect to lubrication openings 40 and 340 in FIGS. 5 and 6. In the embodiments of FIGS. 7-17, the multiple core plugs (whether oriented core plugs 230, 330 or solid core plugs 30, 430) disposed in the cavity 422 are substantially identical with one another, which may achieve cost savings due to economies of scale.

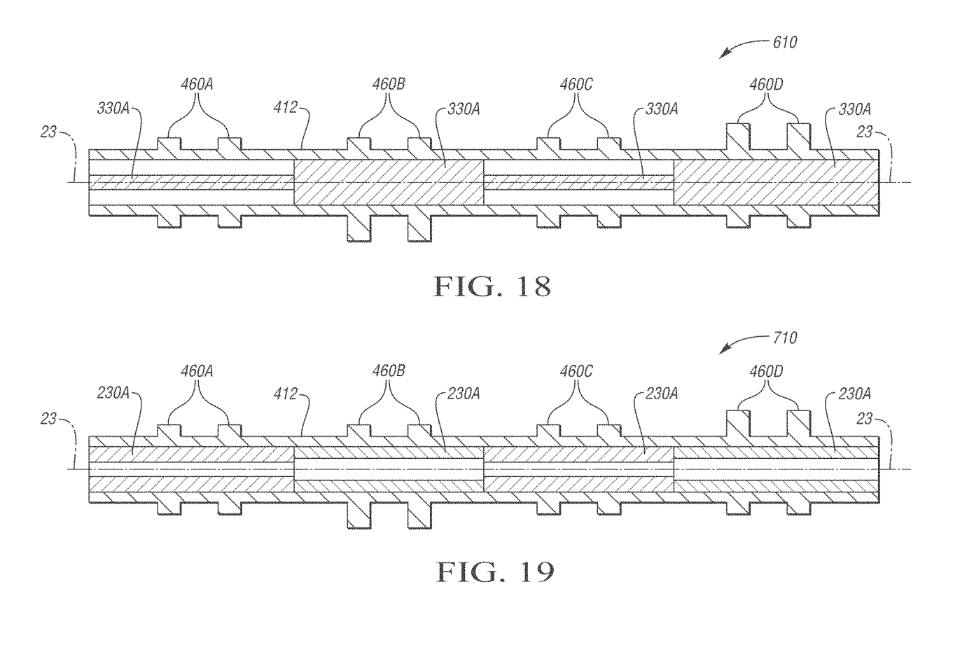

FIG. 18 shows an embodiment of a powertrain shaft assembly 610 that includes the camshaft 412 of FIG. 8 with I-beam shaped core plugs 330A (having a cross-sectional shape at a cross-section perpendicular to the axis 23 the same as core plug 330) angularly oriented in alignment with the noses of the respective cam lobes 460A, 460B, 460C, and 460D, as described with respect to core plugs 330 of FIGS. 14-17, except that the core plugs 330A are longer than the core plugs 330 so that there are no spaces between the core plugs 330A in the cavity 422.

FIG. 19 shows an embodiment of a powertrain shaft assembly 710 that includes the camshaft 412 of FIG. 8 with tri-lobe shaped core plugs 230A (having a cross-sectional shape at a cross-section perpendicular to the axis 23 the same as core plug 230 in FIG. 5) angularly oriented in alignment with the noses of the respective cam lobes 460A, 460B, 460C, and 460D, as described with respect to core plugs 230 of FIGS. 10-13, except that the core plugs 230A are longer than the core plugs 230 so that there are no spaces between the core plugs 230A in the cavity 422.

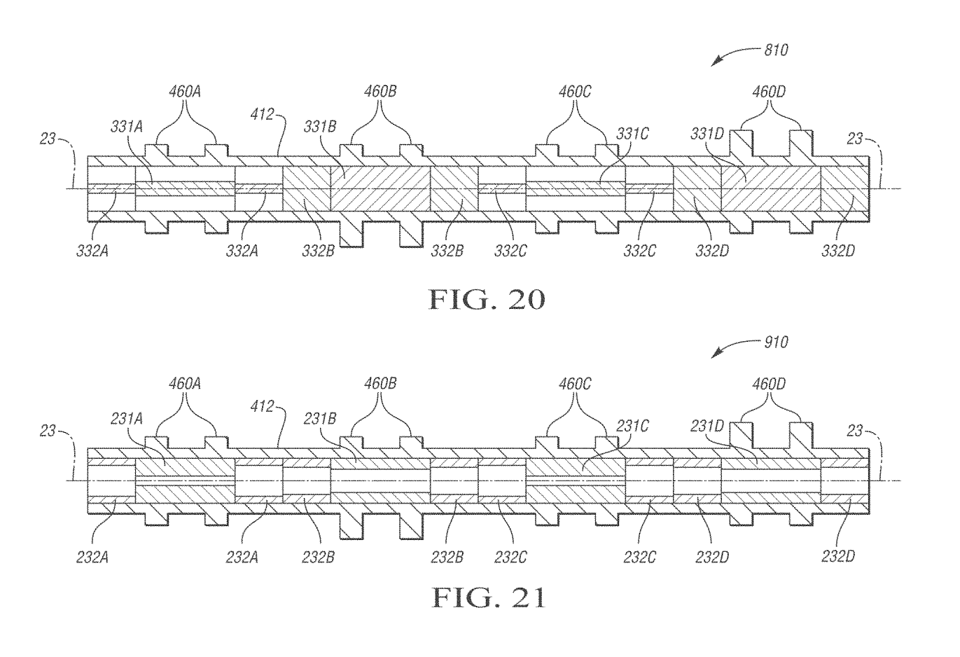

FIG. 20 shows an embodiment of a powertrain shaft assembly 810 that includes the camshaft 412 of FIG. 8 with I-beam shaped core plugs angularly oriented in alignment with the noses of the respective cam lobes 460A, 460B, 460C, and 460D, as described with respect to core plugs 330 of FIGS. 14-17, except that there is a set of three core plugs arranged at each pair of cam lobes 460A, 460B, 460C, and 460D. More specifically, a set of three core plugs is disposed in alignment with cam lobes 460A and includes a relatively heavy core plug 331A and two relatively light core plugs 332A, one disposed on either side of the core plug 331A. The core plug 331A is relatively heavy in that it has a thicker and/or wider leg portion (i.e., like leg portion 348 of core plug 330) than the leg portions of the core plugs 332A, giving it a larger area moment of inertia in bending about the axis 23. Alternatively, the core plug 331A could have the same cross-sectional area and area moment as the core plugs 332A, but could be a more dense material. The relatively heavy core plug 331A is surrounded by the cam lobes 460A and is therefore positioned in a greater stress-bearing portion of the camshaft 412 than the lighter core plugs 332A which are axially displaced from the cam lobes 460A.

A similar set of three core plugs 331B, 332B, and 332B is disposed in alignment with cam lobes 460B and includes a relatively heavy core plug 331B and two relatively light core plugs 332B, one disposed on either side of the core plug 331B. A similar set of three core plugs 331C, 332C, and 332C is disposed in alignment with cam lobes 460C and includes a relatively heavy core plug 331C and two relatively light core plugs 332C, one disposed on either side of the core plug 331C. A similar set of three core plugs 331D, 332D, and 332D is disposed in alignment with cam lobes 460D and includes a relatively heavy core plug 331D and two relatively light core plugs 332D, one disposed on either side of the core plug 331D.

FIG. 21 shows an embodiment of a powertrain shaft assembly 910 that includes the camshaft 412 of FIG. 8 with tri-lobe shaped core plugs angularly oriented in alignment with the nose of the respective cam lobes 460A, 460B, 460C, and 460D, as described with respect to core plugs 230 of FIGS. 10-13, except that there is a set of three core plugs arranged at each pair of cam lobes 460A, 460B, 460C, and 460D. More specifically, a set of three core plugs is disposed in alignment with cam lobes 460A and includes a relatively heavy core plug 231A and two relatively light core plugs 232A, one disposed on either side of the core plug 231A. The core plug 231A is relatively heavy in that it has a smaller tri-lobe opening (like opening 232 of core plug 230) than the core plugs 232A. The relatively heavy core plug 231A is surrounded by the cam lobes 460A and is therefore positioned in a greater stress-bearing portion of the camshaft 412 than the lighter core plugs 232A which are axially displaced from the cam lobes 460A. A similar set of three core plugs 231B, 232B, 232B is disposed in alignment with cam lobes 460B and includes a relatively heavy core plug 231B and two relatively light core plugs 232B, one disposed on either side of the core plug 231B.

A similar set of three core plugs 231C, 232C, 232C is disposed in alignment with cam lobes 460C and includes a relatively heavy core plug 231C and two relatively light core plugs 232C, one disposed on either side of the core plug 231C. A similar set of three core plugs 231D, 232D, 232D is disposed in alignment with cam lobes 460D and includes a relatively heavy core plug 231D and two relatively light core plugs 232D, one disposed on either side of the core plug 231D. By using sets of core plugs as described, the core plugs on either side of the center core plug can be less dense or can have a smaller cross-sectional area or area modulus in bending, reducing the overall mass, while providing greater stiffness in the cavity than if the cavity was empty between the center core plugs.

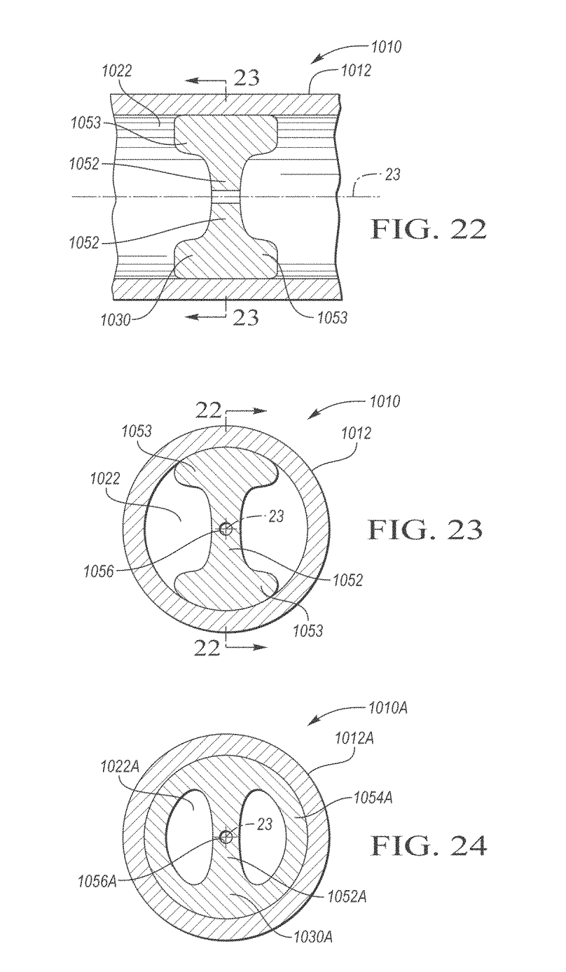

FIGS. 22 and 23 show another embodiment of a powertrain shaft assembly 1010 with a powertrain shaft 1012 and a core plug 1030. The shaft 1012 can be any type of shaft discussed herein, including a camshaft, a balance shaft, or any of the transmission shafts discussed herein and is open at at least one axial end to allow the core plug 1030 to be disposed in the cavity 1022. The core plug 1030 has a center portion 1052 with an I-beam shape in an axial cross-section of FIG. 22. The leg portion 1053 of the core plug 1030 extends along the axis 23 of the shaft 1012 to increase the bending modulus of the core 1030. An optional central axial opening 1056 through the center portion 1052 is also included to reduce the mass of the core plug 1030. It should be recognized that more than two leg portions 1053 can be used, such as when the shaft does not have directional loading. The optimal number of legs may be four, six or eight, or another number. In addition, it should be recognized that shafts may use multiple core plugs 1030 with the same or different cross sectional geometries and locations along the shafts as in FIGS. 7-9, 18-21 to give the optimum mass for the overall powertrain shaft assembly 1010. Additionally, a core plug can be used that has an I-beam shape with two leg portions, and has two side arm portions extending outward from the center portion generally perpendicular to the center portion and oriented at 90 degrees from the leg portions. The side arm portions contact the inner surface of the shaft to provide bracketing support, and may be smaller than the leg portions.

FIG. 24 shows an alternative embodiment of the powertrain shaft assembly 1010A with a powertrain shaft 1012A and a core plug 1030A. The shaft 1012A can be any type of shaft discussed herein, including a camshaft, a balance shaft, or any of the transmission shafts discussed herein and is open at at least one axial end to allow the core plug 1030A to be disposed in the cavity 1022A. The core plug 1030A has a center portion 1052A with an I-beam shape in an axial cross-section similar to FIG. 22, and a surrounding outer annular ring 1054A. An optional central axial opening 1056A through the center portion 1052A is also included to reduce the mass of the core plug 1030A.

In any of the embodiments disclosed herein, if a core plug is used that has an axial opening, one or more plugs can be placed within the axial opening, to provide a core plug within a core plug. For example, another core plug could be placed within the opening 232 of each of the core plugs 230 of FIG. 9. The core plug within the opening 232 would further increase the stiffness of the camshaft 412 at the highly loaded sections, and could be a different material (and/or less or more dense) than the core plug 230.

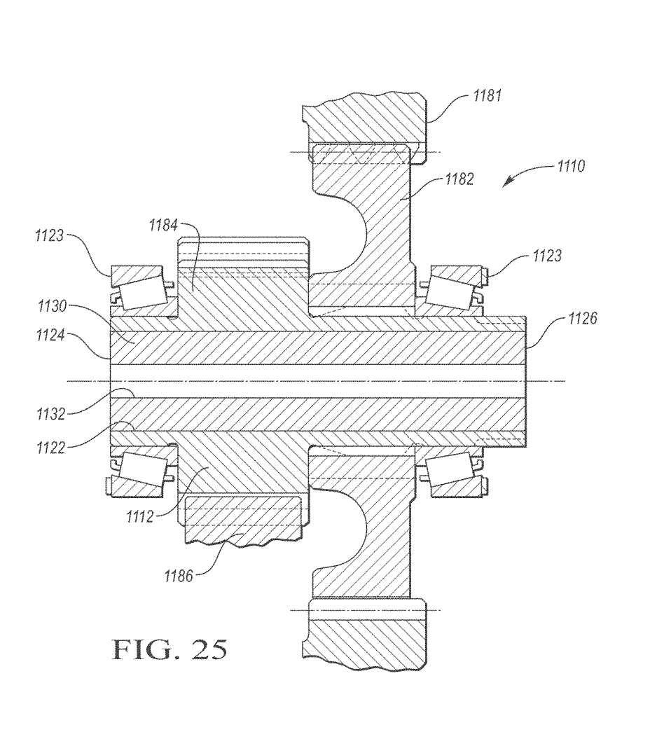

FIG. 25 shows an alternative embodiment of a powertrain shaft assembly 1110 that includes a transmission shaft 1112 with a cavity 1122 that extends from a first axial end 1124 to a second axial end 1126 of the transmission shaft 1112. Bearings 1123 support the shaft 1112. A core plug 1130 is disposed in the cavity 1122 in alignment with a gear 1182 fixed on the shaft 1112 for rotation with the shaft 1112. Another gear 1184 is also fixed on the shaft 1112 for rotation with the shaft 1112. The gear 1184 has a different diameter and tooth count than the gear 1182. Accordingly, when torque is applied to the gear 1182 by a gear 1181 (shown in fragmentary view), the gear 1182 transmits torque to the shaft 1112 to cause rotation of the shaft. The gear 1184 will rotate with the shaft 1112 at the same speed as the gear 1184, but, because gear 1184 has a different diameter and tooth count, another gear 1186 (shown in fragmentary view) meshing with gear 1184 will rotate at a different speed than the shaft 1112.

Torque transfer in this manner creates torsional and bending stresses on the shaft 1112. By aligning the core plug 1130 with a portion of the shaft 1112 experiencing such, the cavity 1122 can be made larger than otherwise, with a net reduction in weight even with the addition of the core plug 1130. An opening 1132 extends through the core plug 1130. The opening 1132 may have any shape, including round (not shown) or the generally triangular shape of FIG. 5. Alternatively, a core plug could be used that has the I-beam shape shown in FIG. 6. The shape chosen of the core plug 1130 can be chosen to enable alignment of lubrication openings in the shaft 1112 with flow desired axially in the shaft as discussed with respect to FIGS. 5 and 6.

Any of the features described herein can be used with the transmission shaft 1112. For example, the shaft 12 in FIG. 2 may represent a transmission shaft with multiple core plugs of different densities disposed in the cavity 22. For example, the first core plug 30 with the first density can be aligned with portions of the transmission shaft experiencing the greatest stress, such as by aligning the core plug with a gear on the shaft that bears the highest torque or bending forces and deflection, while aligning the second core plug 34 with a portion of the transmission shaft 1112 that experiences less stress. If multiple portions of the shaft 1112 experience high stresses, multiple core plugs 30 can be aligned with those portions, with empty spaces or less dense core plugs adjacent to the more dense core plugs 30. By stiffening the shaft 1112 with the core plugs, the bending deflection of the shaft is minimized to help keep the gears in appropriate alignment with other gears (represented in phantom) with which they mesh.

As described with respect to the embodiments of FIG. 3, the transmission shaft 1112 could be machined or otherwise provided with a smaller outer diameter (i.e., thinner wall) at portions that bear less stress. Any of the materials for the core plugs described herein could be used for the core plug 1130 or plugs in the transmission shaft 1112. For example, the core plug 1130 could be a titanium or aluminum core plug.

With the potentially larger cavity 1122 afforded by the use of the core plug 1130, a greater amount of thermal expansion of the shaft assembly 1110 is possible during operation. This may help maintain gear alignment at high operating temperatures. Mass reduction is achieved due to the larger cavity 1122, while the same or greater stiffness of the shaft assembly 1110 (in comparison to a shaft with a cavity smaller than cavity 1122 and without core plug 1130) is possible due to the strategic placement of one or more core plugs in the opening at positions that experience high stress or deflection.

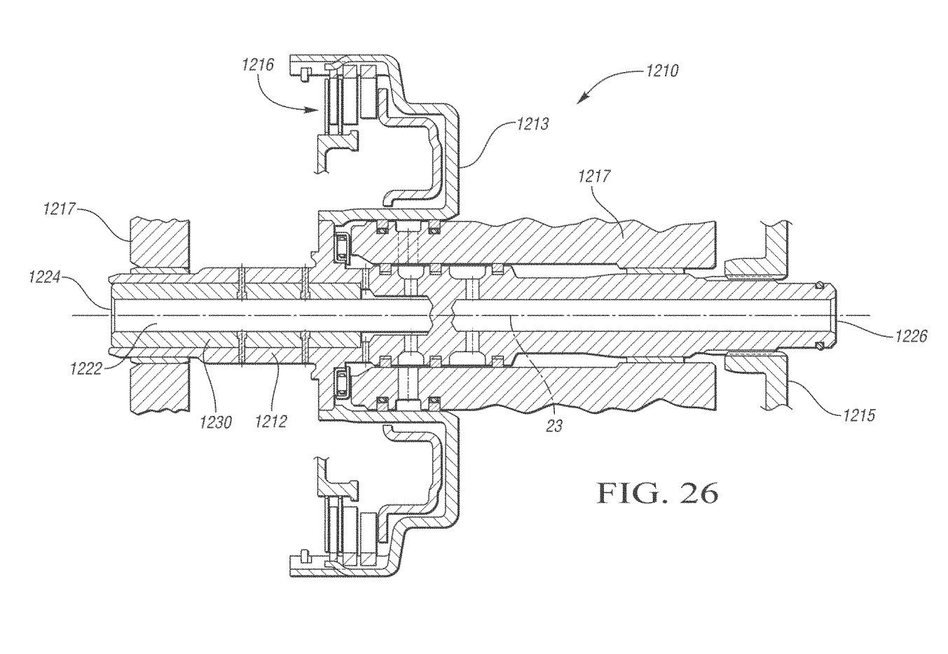

FIG. 26 is another embodiment of a powertrain shaft assembly 1210 that includes a transmission shaft 1212 that supports a clutch housing 1213. The shaft 1212 has a first axial end 1224 and a second axial end 1226. A clutch 1216 can be engaged such as to connect a gear or other rotating component with the shaft 1212, or to ground the shaft 1212 to a stationary member. Supports 1217 surround the shaft 1212 and support its rotation about axis 23 relative to the supports 1217. A drive connection 1215 is splined to the shaft 1212. A core plug 1230 is disposed in a cavity 1222 of the shaft 1212 to provide stiffening of the shaft 1212 in the area of high loading and stress adjacent the clutch housing 1213. As discussed with respect to the other embodiments herein, the core plug 1230 can be a different material, can have a different density or a different cross-sectional area than the shaft 1212.

Accordingly, a method of manufacturing a shaft assembly includes configuring a shaft 12, 112, 312, 412, 1012, 1012A, 1112, 1212, with a cavity 22, 422, 1022, 1122, 1222 extending at least partially from a first axial end to a second axial end of the shaft and opening at at least one of the first axial end and the second axial end. The method further comprises disposing a core plug 30, 230, 230A, 330, 330A, 331A, 332A, 430, 1030, 1030A, 1130, 1230 in the cavity by aligning the core plug with a first portion of the cavity subjected to a first level of stress, such that a second portion of the cavity subjected to a second level of stress less than the first level of stress is empty, or, optionally, has a second core plug disposed therein that is less dense, has a different cross-sectional area or area modulus, or any combination of the three, than the first core plug.

The method further includes orienting the predetermined cross-sectional shape of the opening of the core plug about the axis of rotation at a predetermined angular orientation correlated with a predetermined maximum load on the shaft, such as described with respect to core plugs 230 and 330 and FIGS. 10-17. The predetermined angular orientation is aligned with the nose 470 of a cam lobe, and multiple additional core plugs are disposed in the cavity in correspondence with the multiple additional cam lobes. Sets of core plugs such as described with respect to FIGS. 18-21 can be aligned with the cam lobes without spaces in the cavity between the sets, or there may be spaces in the cavity between the core plugs. Still further, any of the core plugs described herein (whether solid or having a specific geometry that can be oriented with respect to the load) can be placed in areas of relatively high loading or stress, and tubular plugs (i.e., core plugs with a circular center opening) can be placed between the solid or oriented core plugs to provide greater stiffness in comparison to leaving the cavity between the solid or oriented core plugs empty.

The method includes aligning the respective predetermined angular orientation of the opening of each of the multiple additional core plugs with the nose of the respective cam lobe to which the core plug corresponds. The method may further include aligning the core plug with a lubrication opening in the shaft as described with respect to the lubrication openings 40, 340 of FIGS. 5 and 6.

In various embodiments, the method may include casting or forging the shaft 12, 112, 312, 412, 1012, 1012A, 1112, 1212. In one embodiment, the cavity 22, 422, 1022, 1122, 1222 may be drilled in the cast or forged shaft. In another embodiment, when the shaft is cast, the core plug can be cast into the cavity by positioning the core plug in a mold in which the crankshaft is cast. In such an embodiment, the shaft is cast around the core plug, and, optionally, a temporary core that is sand or wax. The core plug will remain in the casting while the temporary core is removed. In another embodiment, a temporary core, such as a sand core or wax core, can be inserted in the mold when the shaft is cast in order to form the cavity. After the shaft is cast, the core is removed and the core plug thereafter inserted in the cavity by casting or press fit insertion.

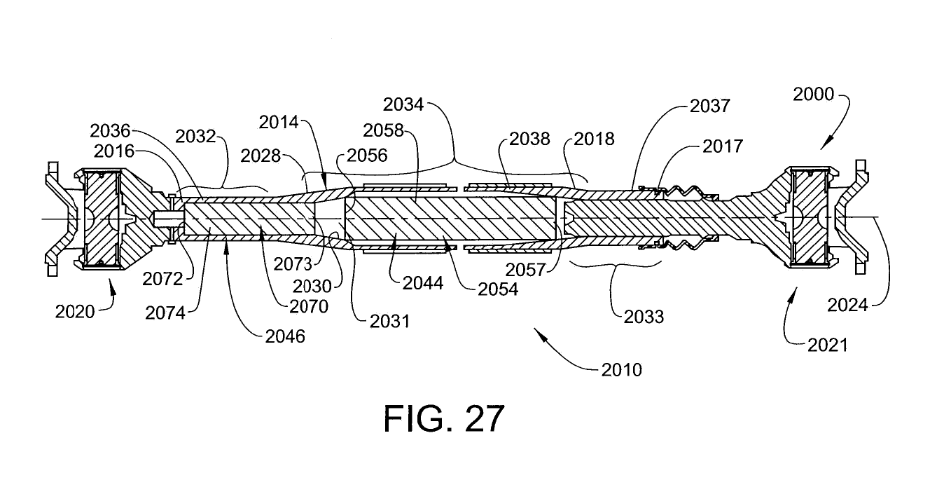

Reference will now follow to FIG. 27 in describing a composite vehicle shaft 2000 shown in the form of a composite propshaft or driveshaft 2010. The term composite, in the context of the exemplary embodiments that follow, should be understood to describe a vehicle shaft formed from two materials which each material providing selected and desirable attributes. As will become apparent below, first portion of the vehicle shaft is formed from a lightweight material, or possesses a geometry that provides support structure while a second portion of the shaft is formed from another material that provides selected strength, stiffness, and/or flexibility attributes. Composite driveshaft 2010 includes a body 2014 having a first end 2016, a second end 2017 and an intermediate portion 2018 extending therebetween and defining an axis of rotation 2024. First end 2016 may include a first joint 2020 that connects composite driveshaft 2010 to a transmission (not shown) and second end 2017 may include a second joint 2021 that may couple composite driveshaft 2010 to a rear differential (also not shown). Body 2014 is formed from a first material such as aluminum, titanium, alloys thereof, or other lightweight materials. It is to be understood that composite driveshaft 2010 may be employed in a rear wheel drive vehicle, a front wheel drive vehicle, an all-wheel drive vehicle, or a rear engine vehicle. In some embodiments, first joint 2020 may connects composite driveshaft 2010 to a bevel gear or half shaft (not shown).

Body 2014 includes an outer surface 2028 and an inner surface 2030 that defines a cavity 2031. Body 2014 may be formed from steel or alloys thereof and includes a first portion 2032 that extends axially outwardly from first end 2016 towards second end 2017, a second portion 2033 that extends axially outwardly from second end 2017 toward first end 2016, and a third portion 2034 that extends between first portion 2032 and second portion 2033. First portion 2032 may be subjected to a first level of bending stresses and/or displacement while third portion 2034 may be subjected to a second level of bending stresses and/or displacement that is greater than the first level. Second portion 2033 may experience bending stresses at the first level or at another level.

In accordance with an aspect of an exemplary embodiment, first portion 2032 may include a first wall thickness 2036 defined between outer surface 2028 and inner surface 2030, second portion 2033 may include a second wall thickness 2037 defined between outer surface 2028 and inner surface 2030, and third portion 2034 may include a third wall thickness 2038 defined between outer surface 2028 and inner surface 2030. Given that third portion 2034 may experience greater bending stresses, third wall thickness 2038 may be greater than first wall thickness 2036 and second wall thickness 2037. Alternatively, third portion 2034 may be formed to have an outer diameter that is larger than outer diameters of first portion 2032 and second portion 2033.

In further accordance with an exemplary embodiment, composite driveshaft 2010 includes a first core plug 2044 arranged in cavity 2031 at third portion 2034 and may also include a second core plug 2046 arranged in cavity 2031 at first portion 2032. As shown in FIG. 27, first core plug 2044 may include a body portion 2054 having a first end portion 2056, a second end portion 2057 and an intermediate section 2058 extending therebetween.

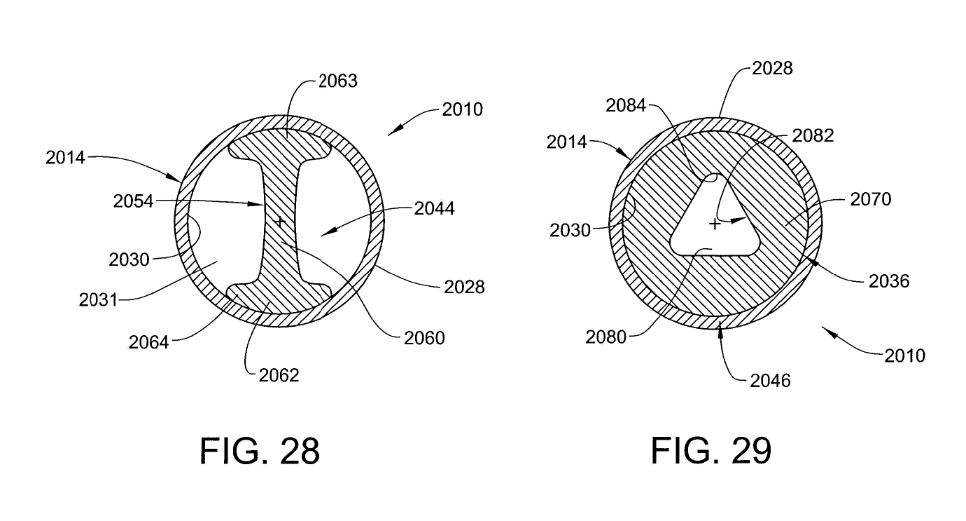

Body portion 2054 may be formed from a second material that is generally lighter than the first material. For example, the second material may comprise aluminum, titanium, or other lightweight alloys thereof. As shown in FIG. 28, body portion 2054 includes a center portion 2060, a first leg portion 2062 extending radially outwardly from center portion 2060 and a second leg portion 2063 extending radially outwardly from center portion 2060 opposite to first leg portion 2062. First and second leg portions 2062 and 2063 may each include corresponding foot portions, one of which is indicated at 2064 on first leg portion 2062. In this manner, first core plug 2044 includes a generally I-shaped cross-section. Foot portions 2064 interface with inner surface 2030 of composite driveshaft 2010.

In accordance with another aspect of an exemplary embodiment, second core plug 2046 may be similar to first core plug 2044. Alternatively, second core plug 2046 may include a body portion 2070 formed from the second material. Body portion 2070 includes a first end portion 2072, a second end portion 2073 and an intermediate portion 2074 extending therebetween (FIG. 27). As seen in FIG. 29, a passage 2080 having a generally triangular cross-sectional shape may extend through intermediate portion 2074 and be open at each of first and second end portions 2072 and 2073. Passage 2080 may include a predetermined cross-section 2082 having multiple peaks 2084 that may be selectively aligned relative to composite driveshaft 2010. It is to be understood that first core plug 2044 may be similar to second core plug 2046.

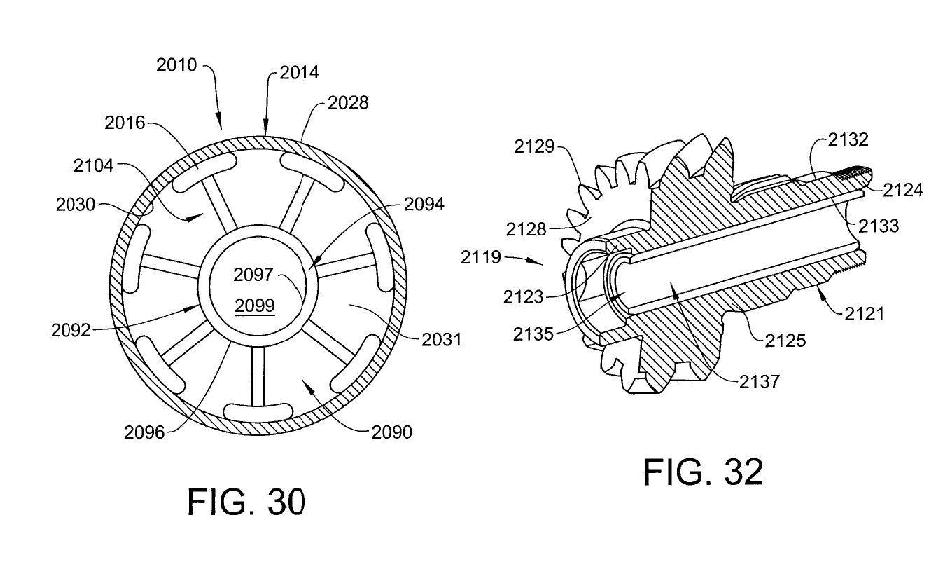

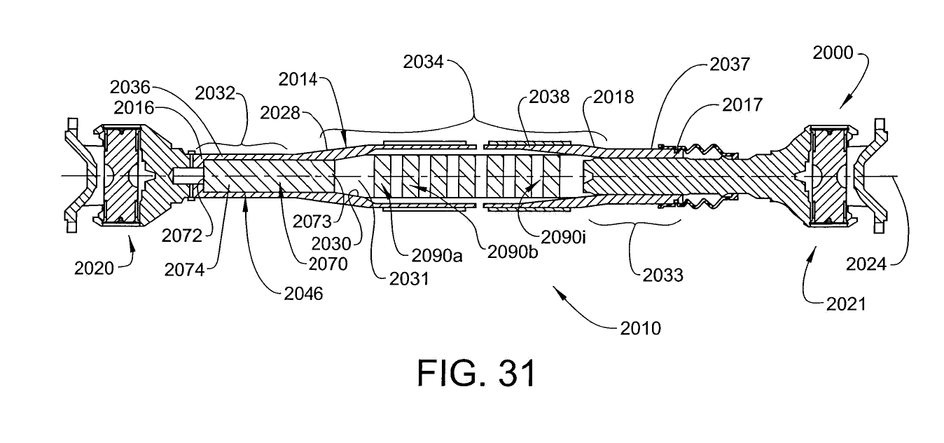

In accordance with still another aspect of an exemplary embodiment illustrated in FIG. 30, composite vehicle shaft 2010 may include a core plug 2090. Core plug 2090 includes a body portion 2092 that may be formed from the second material. Body portion 2092 includes a central portion 2094 having an outer surface portion 2096 and an inner surface portion 2097 that forms a passage 2099. It is to be understood that central portion 2094 may also be formed without a passage. In the exemplary embodiment shown, core plug 2090 includes a plurality of leg portions, one of which is indicated at 2104. Each leg portion 2014 includes a corresponding foot portion 2016 that engages inner surface 2030 of composite driveshaft 2010. At this point, it should be understood that multiple core plugs 2090a-2090i may be installed in cavity 2031 of composite driveshaft 2010 as shown in FIG. 31 wherein like numbers represent corresponding parts in the separate views. It is also to be understood that body portion 2092 may be formed from various materials and, in an example, could be formed from the first material.

A composite vehicle shaft in accordance with another aspect of an exemplary embodiment, shown in the form of a composite transfer shaft 2119 is shown in FIG. 32. Composite transfer shaft 2119 includes a body 2121 formed from the first material. Body 2121 includes a first end 2123, a second end 2124, and an intermediate portion 2125 extending therebetween. Intermediate portion 2125 supports a gear component 2128 having a plurality of gear teeth 2129. Body 2121 includes an outer surface 2132 and an inner surface 2133 that defines a cavity 2135. Composite transfer shaft 2119 includes a core plug 2137 arranged in cavity 2135. Core plug 2137 may take on a variety of forms and is formed from the second material.

At this point it should be understood that exemplary embodiments describe a composite shaft formed from two materials which each provide desirable attributes. A first portion of the shaft is formed from a lightweight material, or possesses a geometry that provides support structure while a second portion of the shaft is formed from another material that provides selected strength, stiffness, and/or flexibility attributes. In this manner, a lightweight composite shaft can be formed to meet desired operational parameters. It should be also understood that the use of core plugs may allow for increased diameter portions to have a smaller diameter thereby improving clearances relative to a transmission or other vehicle components. It should be further understood that the core plug(s) may include a first density or modulus and the portions of the shaft that support a core plug(s) may include a second density or modulus. Further, each core plug may include a different density and/or modulus depending upon localized design constraints.

While the best modes for carrying out the many aspects of the present teachings have been described in detail, those familiar with the art to which these teachings relate will recognize various alternative aspects for practicing the present teachings that are within the scope of the appended claims.

What is claimed is:

1. A composite vehicle shaft assembly comprising:
a body formed from a first material including a first end, a second end, and an intermediate portion extending therebetween, the intermediate portion defining an axis of rotation and including an outer surface and an inner surface defining a cavity; and
at least one core plug formed from a second material disposed in the cavity.

2. The composite vehicle shaft assembly according to claim 1, wherein the body has a first portion subjected to one of a first level of stress and first displacement and a second portion subjected to one of a second level of stress and second displacement that is greater than the one of the first level of stress and the first displacement, wherein the at least one core plug is disposed in the cavity at the second portion.

3. The composite vehicle shaft assembly of claim 1, wherein the first end has one of a first wall thickness and a first outer diameter and the intermediate portion has one of a second wall thickness and a second outer diameter, the one of the second wall thickness and the second outer diameter is distinct from the one of the first wall thickness and first outer diameter.

4. The composite vehicle shaft assembly of claim 3, wherein the first end includes the first wall thickness and the intermediate portion includes the second wall thickness, the first wall thickness being greater than the second wall thickness.

5. The composite vehicle shaft assembly of claim 3, wherein the first end includes the first outer diameter and the intermediate portion includes the second outer diameter, the second outer diameter being greater than the first outer diameter.

6. The composite vehicle shaft assembly of claim 1, wherein the at least one core plug includes a first end portion, a second end portion, an intermediate section extending therebetween, and a passage extending at least partially from the first end portion to the second end portion through the intermediate section.

7. The composite vehicle shaft assembly of claim 6, wherein the passage includes a predetermined cross-sectional shape positioned about the axis of rotation at a predetermined selected orientation.

8. The composite vehicle shaft assembly of claim 7, wherein the predetermined cross-sectional shape is a generally triangular cross-sectional shape.

9. The composite vehicle shaft assembly of claim 1, wherein the at least one core plug includes a center portion and at least two leg portions.

10. The composite vehicle shaft assembly of claim 9, wherein the at least two leg portions includes at least four leg portions.

11. The composite vehicle shaft assembly of claim 1, wherein the at least one core plug comprises a plurality of core plugs.

12. The composite vehicle shaft assembly of claim 1, wherein the composite vehicle shaft assembly defines one of a driveshaft, and a transfer shaft.

13. The composite vehicle shaft assembly of claim 1, wherein the first material is distinct from the second material.

14. The composite vehicle shaft assembly of claim 13, wherein the first material comprises steel and the second material comprises aluminum.

15. A method of manufacturing a composite vehicle shaft assembly comprising:
disposing at least one core plug formed from a first material in a cavity formed in a shaft body formed from a second material.

16. The method of claim 15, wherein disposing the at least one core plug in the cavity includes aligning the at least one core plug with a first portion of the cavity subjected to a first level of stress, such that a second portion of the cavity that is subjected to a second level of stress less than the first level of stress.

17. The method of claim 15, wherein disposing the at least one core plug in the cavity includes disposing at least one core plug having a central portion and at least two leg portions extending radially outwardly of the central portion in the cavity.

18. The method of claim 15, wherein disposing the at least one core plug formed from the first material in the cavity formed in the shaft body formed from the second material, includes disposing at least one core plug formed from steel in a shaft body formed from aluminum.

19. The method of claim 15, wherein disposing the at least one core plug in the cavity formed in the shaft body includes disposing a plurality of core plugs in the cavity.

20. The method of claim 15, wherein disposing the at least one core plug in the cavity formed in the shaft body includes installing at least one core plug having an passage extending at least partially from a first end portion to a second end portion of the shaft body.
